(19) United States
(12) Patent Application Publication
(10) Pub. No.: US 2022/0316757 A1
(43) Pub. Date: Oct. 6, 2022

(54) INNER PIPE FOR LIQUID HEATING APPARATUS, AND LIQUID HEATING APPARATUS AND MANUFACTURING METHOD THEREFOR

(71) Applicant: HEATING LEADER ELECTRONIC TECHNOLOGY CO., LTD, FOSHAN (CN)

(72) Inventor: SHAOLING DU, FOSHAN (CN)

(21) Appl. No.: 17/808,558

(22) Filed: Jun. 24, 2022

Related U.S. Application Data
(63) Continuation of application No. PCT/CN2020/139249, filed on Dec. 25, 2020.

(30) Foreign Application Priority Data
Dec. 26, 2019 (CN) 201911365384.6

(51) Int. Cl. F24H 1/08; F24H 9/00; F24H 9/20; F24H 15/219; B21D 26/033; A47J 31/54; A47J 31/56

(52) U.S. Cl. CPC F24H 1/08; F24H 9/0015; F24H 9/2028; F24H 15/219; B21D 26/033; A47J 31/542; A47J 31/56

(57) ABSTRACT

The present invention discloses an inner pipe for a liquid heating apparatus, including a hollow pipe body made of a metal or an alloy, where a pipe wall thickness of the pipe body is 0.3-1.0 mm; through a machining method of rolling or pressing, a spiral diversion structure is machined on an inner peripheral wall of the pipe body along an axial direction of the pipe body, so that the spiral division structure is formed to extend along the axial direction of the pipe body. The present invention further discloses a liquid heating apparatus and a manufacturing method therefor. The liquid heating apparatus includes the inner pipe and the outer pipe; a heating assembly is disposed on the outer peripheral wall of the outer pipe.

### TECHNICAL FIELD

The present invention relates to the field of thick film heating techniques, and in particular, to an inner pipe for a liquid heating apparatus, and a liquid heating apparatus and a manufacturing method therefor, for example, a heating apparatus for devices such as an instant heating water dispenser and an instant heating coffee machine.

### BACKGROUND

An assembly for continuously heating liquid is generally applied to a heating electric appliance needing to continuously output hot water, such as heating apparatuses in a coffee machine, a beverage heater, and a heating steam engine. Such a heating electric appliance in the prior art generally includes an inner pipe of a liquid flow path and an external heating pipe for heating. An outer wall of the external heating pipe is printed with a thick film circuit. when the thick film circuit is energized to heat, liquid passing through the liquid flow path of the inner pipe is heated.

The liquid flow path of the liquid heating apparatus in the prior art is generally implemented by adding a diversion mechanism on the inner pipe, and the diversion mechanism and the inner pipe are manufactured separately and then fixed to each other. Plastic, rubber, and other materials are generally used. Due to certain elasticity, the plastic and rubber can make a gap between the liquid flow path and the external heat pipe relatively small, so that liquid can only flow from a liquid inlet to a liquid outlet along a flow defined by the liquid flow path, to improve heating performance. However, since during heating, the temperature of the liquid flow path may reach 300° C., the plastic and rubber materials are prone to produce a peculiar smell. A process for producing food-grade rubber is complex and has a high cost, and when the rubber is encountered with water in a high temperature and high pressure environment, due to excessively high temperature, it may age, generate odor, and even produce substances harmful to human health. In addition, long-term high temperature heating easily causes the diversion mechanism to shake and become unstable, resulting in falling off, blocking the flow path, and resulting in a smaller water output or even no water output.

In addition, the liquid flow path is usually sealed by a sealing ring, and the sealing ring is prone to aging, deformation, and loss of sealing effect in the high temperature environment for a long time. Liquid is prone to flow to the heating thick film circuit, and there are safety risks.

### SUMMARY

To overcome disadvantages of the prior art, objectives of the present invention are to provide an inner pipe for a liquid heating apparatus, and a heating apparatus and a manufacturing method therefor, so that through a combined design of a spiral diversion structure machined and formed on an inner pipe wall in a mode of rolling or pressing, an inner pipe, and an outer pipe with a heating assembly, the high temperature and high pressure resistance performance of the heating apparatus is enhanced, and the safety of the heating liquid is ensured.

A first objective of the present invention is implemented using the following technical solution:

An inner pipe for a liquid heating apparatus includes a hollow pipe body made of a metal or an alloy, where a pipe wall thickness of the pipe body is 0.3-1.0 mm; through a machining method of rolling or pressing, a spiral diversion structure is machined on an inner peripheral wall of the pipe body along an axial direction of the pipe body, so that the spiral division structure is formed to extend along the axial direction of the pipe body, protrude on an outer peripheral wall of the pipe body, and be sunken on the inner peripheral wall.

Furthermore, the inner pipe further includes expanded ports disposed at two ends of the pipe body and integrated with the pipe body.

Furthermore, on the inner peripheral wall of the pipe body, a first through hole penetrating a pipe wall of the pipe body is disposed at a start position of the spiral diversion structure, so that the first through hole communicates with the inner peripheral wall and the outer peripheral wall of the pipe body, and a flow path inlet is formed at a joint between the first through hole and the inner peripheral wall of the pipe body; and a second through hole penetrating the pipe wall of the pipe body is disposed at an end position of the spiral diversion structure, so that the second through hole communicates with the inner peripheral wall and the outer peripheral wall of the pipe body, and a flow path outlet is formed at a joint between the second through hole and the inner peripheral wall of the pipe body.

Furthermore, a surface height of the spiral diversion structure protruding on the outer peripheral wall of the pipe body is 1-5 mm, and a thread spacing is 5-20 mm.

A second objective of the present invention is implemented using the following technical solution:

A liquid heating apparatus includes:

the inner pipe described above, where openings at two ends of the inner pipe are sealed by end covers made of a metal material; and

an outer pipe, where an inner peripheral wall of the outer pipe is spaced apart from a highest point of the spiral diversion structure by a predetermined radical clearance, so that the outer pipe is sleeved at an outer part of the spiral diversion structure; and a heating assembly is disposed on the outer peripheral wall of the outer pipe; where the inner pipe, the outer pipe, and the spiral diversion structure form a flow path; openings at two ends of the flow path are sealed by sealing covers; the sealing cover is provided with a first through hole or a second through hole; and liquid enters the flow path through the first through hole of the sealing cover for heating and is discharged from the second through hole.

A third objective of the present invention is implemented using the following technical solution:

A liquid heating apparatus includes:

an inner pipe described above; and

an outer pipe, where an inner peripheral wall of the outer pipe is spaced apart from a highest point of the spiral diversion structure by a predetermined radical clearance, so that the outer pipe is sleeved at an outer part of the spiral diversion structure; and a heating assembly is disposed on the outer peripheral wall of the outer pipe; where

the inner pipe, the outer pipe, and the spiral diversion structure form a flow path; and openings at two ends of the flow path are sealed by the expanded ports.

Furthermore, a liquid inlet pipe is disposed at an inlet of the flow path; a liquid outlet pipe is disposed at an outlet of the flow path; and the liquid inlet pipe or the liquid outlet pipe extends towards directions of the openings of two ends of the inner pipe through the first through hole or the second through hole, and is exposed at the openings at the two ends of the inner pipe.

Furthermore, the expanded port is welded to and sealed with an end of the outer pipe; and the liquid inlet pipe or the liquid outlet pipe is welded to the first through hole or second through hole.

Furthermore, the liquid inlet pipe is connected to a water pump, and a diameter of the liquid outlet pipe is not greater than a diameter of the liquid inlet pipe, to keep a liquid pressure in the flow path at 0.1-1.0 MPa.

Furthermore, the inner pipe and the expanded port are both made of a stainless steel material.

Furthermore, the liquid heating apparatus further includes a temperature sensor and a controller electrically connected to the temperature sensor, where the temperature sensor is configured at a place of the outer pipe close to the second through hole, and the controller is configured to control, according to temperature information issued by the temperature sensor, the water pump liquid inlet speed and/or heating power of the heating assembly.

A fourth objective of the present invention is implemented using the following technical solution:

A method for preparing a liquid heating apparatus is provided, where the method is used to prepare the liquid heating apparatus described above and includes the following steps:

S1: preparing a mold according to preset parameters of an inner pipe, and placing the mold into a pressure device; and setting parameters and debugging the device, where the preset parameter includes an inner pipe thickness, a height of an expanded port, and a height and a spacing of a spiral diversion structure;

S2: placing a metal material or a metal alloy material into the mold, and sealing and locking the mold; and annealing the metal material or the metal alloy material;

S3: starting the pressure device, performing pushing wave forming by using a high-pressure water drum, to complete machining, and integrating the spiral diversion structure with a pipe body;

S4: releasing pressure and loosening the mold, and taking out the prepared inner pipe; and

S5: inserting the inner pipe in an outer pipe, so that a spacing between a highest point of the inner pipe and the outer pipe is 0.1-0.6 mm; aligning two ends of the inner pipe and the outer pipe; and welding an opening to implement sealing.

Compared with the prior art, the present invention has the following beneficial effects.

The present invention provides an inner pipe for a liquid heating apparatus, and a liquid heating apparatus and a manufacturing method therefor, where an inner pipe made of a metal or alloy material, a spiral diversion structure machined and formed on an inner pipe in a mode of rolling or pressing, and the outer pipe form a stable liquid flow path, the inner pipe is integrally formed with the spiral diversion structure, thereby avoiding the aging, unsafety, ease of falling off, and other problems that are prone to occur in the conventional heating apparatus when the diversion structure is added on the inner pipe wall. It is easy to implement mass production, the production materials are saved, the manufacturing cost is reduced, and the stability performance of the liquid heating apparatus in the high temperature and high pressure environment for a long time is improved.

### BRIEF DESCRIPTION OF DRAWINGS

FIG. 1 is a structural schematic diagram of Embodiment 1 provided by the present invention;

FIG. 2 is a structural schematic diagram of Embodiment 2 provided by the present invention;

FIG. 3 is a structural schematic diagram of Embodiment 3 provided by the present invention;

FIG. 4 is a structural schematic diagram of Embodiment 3 provided by the present invention; and

FIG. 5 is a cross-section of Embodiment 3 provided by the present invention.

In the figures: 10. inner pipe; 11. spiral diversion structure; 12. flow path; 13. expanded port; 14. second through hole; 15. first through hole; 16. liquid outlet pipe; 17. liquid inlet pipe; 18. pipe body; 20. outer pipe; 21. heating assembly; 22. heating circuit; 23. temperature sensor; 24. electrode; 30. end cover; 31. bump; 40. sealing cover; 41. sealing face; 42. liquid outlet; 43. liquid inlet.

### DESCRIPTION OF EMBODIMENTS

The present invention is further described with reference to the accompanying drawings and specific implementations below. It should be noted that, new embodiments can be formed by any combination between the embodiments or between technical features described below provided that no conflict occurs.

In the description of the present invention, it should be understood that, orientations or position relationships indicated by terms such as “center”, “longitudinal”, “transverse”, “up”, “down”, “front”, “rear”, “left”, “right”, “horizontal”, “vertical”, “top”, “bottom”, “inner”, and “outer” are orientations or position relationships shown based on the accompanying drawings, and are used for only ease of describing the present invention and simplifying the description, rather than indicating or implying that the apparatus or elements must have a particular orientation or be constructed and operated in a particular orientation, and therefore, should not be construed as a limitation on the present invention. In addition, terms “first” and “second” are used merely for description, and shall not be construed as indicating or implying relative importance.

In the description of the present invention, it should be noted that unless otherwise explicitly specified and defined, terms such as “mounted”, “connected”, and “connection” should be understood in a broad sense, for example, the connection may be a fixed connection, a detachable connection, or an integral connection; or the connection may be a mechanical connection or an electrical connection; or the connection may be a direct connection, an indirect connection through an intermediary, or internal communication between two elements. A person of ordinary skill in the art may understand specific meanings of the foregoing terms in the present invention according to specific situations.

### Embodiment 1

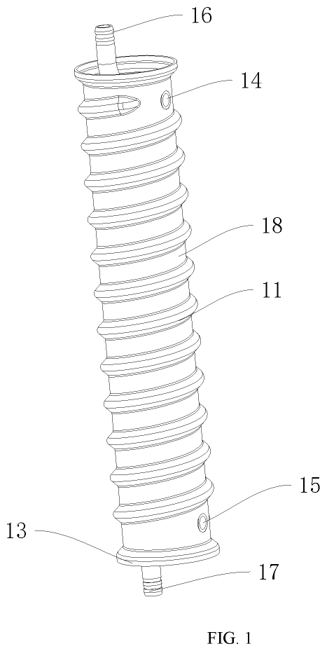

As shown in FIG. 1, the present invention provides an inner pipe 10 for a liquid heating apparatus, specifically including a hollow pipe body 18 made of a metal or an alloy. In a preferable embodiment, the inner pipe 10 is made of a stainless steel material, for example, made of a 304 stainless steel material. The spiral diversion structure 11 is formed by machining at the outer peripheral wall of the inner pipe 10 along the axial direction of the pipe body 18 through a mold or a stainless steel pipe, so as to extend along the axial direction of the pipe body 18 and protrude from the outer peripheral wall of the pipe body 18 to form a spiral protrusion, and therefore, a corresponding position of the surface of the inner peripheral wall of the inner pipe 10 is sunken. Integral forming through the mold avoids the situation that the inner pipe 10 and the diversion structure are separately manufactured and then fixed to each other in the conventional heating apparatus, which is prone to shaking and instability, resulting in falling off, and a change in a sectional area of the flow path 12 affects the liquid inflow or outflow. Volumes needed by the inner pipe 10 and the spiral diversion structure 11 are reduced while it is ensured that a water flow passes through the flow path 12, so as to further reduce the diameter of the outer pipe 20 adaptive to the inner pipe 10, which is adapted to a small liquid heating apparatus. Moreover/alternatively, the inner peripheral wall of the inner pipe 10 has threads with an axial sectional shape of triangle or trapezoid or rectangle or circle. The triangle or trapezoid bottom edge is disposed at the outer peripheral wall of the pipe body 18, and the flow path 12 formed in this way has a simple structure, is easy to generate, and has more stable diversion performance.

In a preferable implementation, the pipe wall thickness of the pipe body 18 is 0.3-1.0 mm; the surface height of the spiral diversion structure 11 is 1-5 mm; the thread spacing of the surface of the inner pipe 10 is 5-20 mm. In this embodiment, the surface height of the spiral diversion structure 11 is 1.8 mm, and the thread spacing is 6 mm. The spiral diversion structure 11 is used in cooperation with the outer pipe 20 sleeved outside the inner pipe 10 in the liquid heating apparatus.

### Embodiment 2

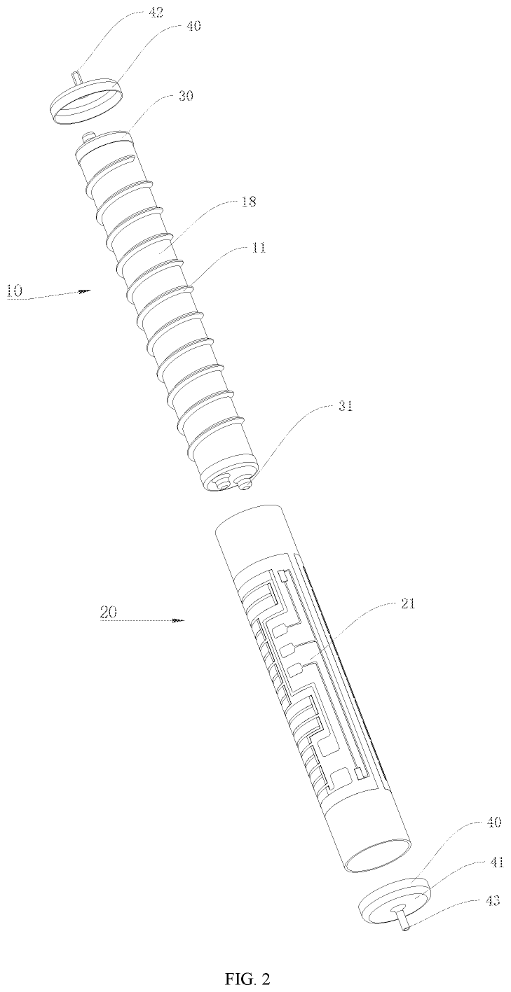

As shown in FIG. 2, the present invention further provides a liquid heating apparatus, which includes the inner pipe 10 in embodiment 1, where two ends of the inner pipe 10 are sealed by end covers 30 made of a metal material, and the outer pipe 20, where an inner peripheral wall of the outer pipe 20 is spaced apart from a highest point of the spiral diversion structure 11 by a predetermined radical clearance, so that the outer pipe 20 is sleeved at an outer part of the spiral diversion structure 11; a heating assembly 21 is disposed on the outer peripheral wall of the outer pipe 20; the inner pipe 10, the outer pipe 20, and the spiral diversion structure 11 form a flow path 12; openings at two ends of the flow path 12 are sealed by sealing covers 40; and the sealing covers 40 are each provided with a liquid inlet 43 or a liquid outlet 42, and liquid enters the flow path 12 through the liquid inlet 43 of the sealing cover 40 for heating and is discharged through the liquid outlet 42.

End covers 30 are sleeved at two ends of the inner pipe 10 respectively; the end covers 30 each include an end cover wall and an end cover face connected to the end cover wall; the end cover wall and the outer peripheral wall sealing of the inner pipe 10 are sealed and fixed by welding. Two ends of the flow path 12 are sealed by the sealing covers 40; the sealing covers 40 each include a sealing wall and a sealing face 41 connected to the sealing wall; the sealing wall and the outer peripheral wall of the outer pipe 20 are sealed and fixed by welding. The sealing face 41 is provided with a liquid inlet 43 and the liquid outlet 42; after the liquid to be heated enters, through the liquid inlet 43, the flow path 12 formed by the spiral division structure 11, the outer peripheral wall of the inner pipe 10, and the inner peripheral wall of the outer pipe 20, the heating assembly 21 integrated at the outer peripheral wall of the outer pipe 20 heats the flowing liquid while the liquid to be heated flows along the flow path 12. After passing through the outer pipe 20, the heat energy generated by the heating assembly 21 exchanges heat energy with the liquid in the flow path 12 to implement continuous heating of the liquid. In addition, the end cover 30 and the sealing cover 40 are used for sealing the inner pipe 10 and the outer pipe 20 respectively; the sealing structures of the inner pipe 10 and the outer pipe 20 are separately and independently processed to facilitate manufacturing; moreover, the sealing effect is good, to improve the stability of the liquid heating apparatus in a high temperature and high pressure environment for a long time. Moreover, the end cover 30, the sealing cover 40, the inner pipe 10, and the outer pipe 20 are all made of a stainless steel material, facilitating the fixedly welding therebetween.

The end cover 30 is provided with a bump 31 for fixing the position of the inner pipe 10, and an orthographic projection of the pump 31 does overlap an orthographic projection of the liquid inlet 43 or the liquid outlet 42. The number of the bumps 31 may be set according to actual conditions. In this embodiment, the number of the bumps 31 is preferably two, the bumps 31 are located at two sides of the liquid inlet 43 or liquid outlet 42 respectively, to ensure uniform stress during mounting. Since the inner pipe 10 needs to be sleeved inside the outer pipe 20 and the sealing cover 40, the height of the bump 31 is less than or equal to the distance between the upper end cover 30 and the upper sealing cover 40 or between the lower end cover 30 and the lower sealing cover 40, to avoid failure of sealing between the sealing cover 40 and the outer pipe 20. The bump 31 may be triangular or trapezoidal or rectangular or semi-elliptical in sectional shape. The bottom of the triangle or the trapezoid or the semi-ellipse is fixed to the surface of the end cover 30, and is not in excessive contact with the sealing cover 40, and does block the regular flowing of the water stream.

The radical clearance between the inner peripheral wall of the outer pipe 20 and the highest point of the spiral diversion structure 11 is in a range of the preset numeral value, to enable the inner pipe 10 to be easily sleeved into the outer pipe 20, and also avoid the problems that because the radical clearance is excessively large, the liquid directly flows to the liquid outlet 42 along the length of the inner pipe 10 through the radical clearance rather than diverting along the flow path 12 of the outer peripheral wall of the inner pipe 10, resulting in local standstill of liquid in the flow path 12, and continuous heating of the heating assembly 21 causes local overheating, so that the standstill liquid at this spot is vaporized to produce and discharge vapor, thereby causing the liquid to be discharged from the liquid outlet 42 discontinuously with a large amount of bubbles. The embodiment provided by the present invention proves, through a large amount of experiments, that when the radical clearance is set in the range of 0.1-0.6 mm, the liquid can be fully heated, the heating effect is good, and it can be further ensured that the liquid flows smoothly while excessive heating of the liquid is avoided, and the generation of large bubbles can be prevented.

### Embodiment 3

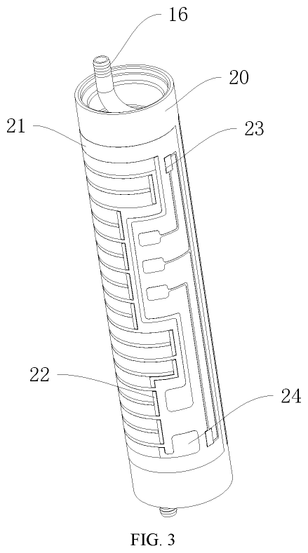

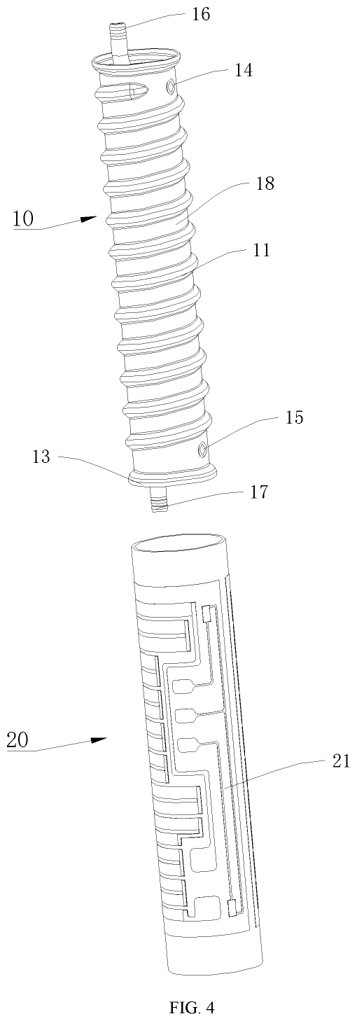

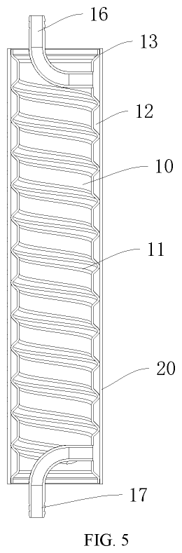

As shown in FIG. 3, FIG. 4, and FIG. 5, the present invention further provides another liquid heating apparatus, which includes the inner pipe 10 and the outer pipe 20 according to Embodiment 1. An inner peripheral wall of the outer pipe 20 is spaced apart from a highest point of the spiral diversion structure 11 by a predetermined radical clearance, so that the outer pipe 20 is sleeved at an outer part of the spiral diversion structure 11; a heating assembly 21 is disposed on the outer peripheral wall of the outer pipe 20; and the inner pipe 10, the outer pipe 20, and the spiral diversion structure 11 form a flow path 12. Different from Embodiment 2, the openings at two ends of the flow path 12 are sealed by the expanded ports 13 disposed at two ends of the pipe body 18.

The openings at the two ends of the inner pipe 10 are each provided with the expanded port 13; the expanded port 13 extends from a direction of the outer peripheral wall of the pipe body 18 away from the opening; and the expanded port 13 and the outer peripheral wall of the pipe body 18 can be integrated by welding or through the mold. In this embodiment, the expanded port 13 and the pipe body 18 are integrated made through the mold; the sealing performance is good and the structure is stable; and after high temperature heating for a long time, the structure does not fall off. The inner pipe 10 is first sleeved into the outer pipe 20; the two ends of the inner pipe 10 and the outer pipe 20 are kept flush, and then the expanded ports 13 at the two ends of the inner pipe 10 are welded and fixed to the inner peripheral wall of the outer pipe 20, to implement the sealing of the flow path 12.

The pipe body 18 and the expanded port 13 are both made of 304 stainless steel, have corrosion resistance, heat resistance, and good mechanical properties; the room temperature machining performance is relatively good, and erosion by a food processing medium can be resisted. The liquid is in directly contact with the inner pipe 10; 304 stainless steel material is not prone to rust and harmless to human body. Under the condition of long-term high temperature and high pressure, the phenomenon of blocking the flow path 12 caused by aging and bubbling of the plastic, rubber, and other materials due to heating is avoided. More importantly, unpleasant odor generated and toxic substances decomposed by long time heating of the plastic and rubber are avoided; and liquid can be rapidly heated, improving the use safety of the heated liquid and the service life of this liquid heating apparatus. The inner pipe 10 for the liquid heating apparatus provided by the present application has a low manufacturing cost, meets food sanitation, and can pass a salt spray test. However, the material is not limited to only the stainless steel materials, and using an aluminum alloy or a titanium alloy materials are also within the scope of protection of the present invention.

On the inner peripheral wall of the pipe body 18, a first through hole 15 penetrating a pipe wall of the pipe body 18 is disposed at a start position of the spiral diversion structure 11, so that the first through hole 15 communicates with the inner peripheral wall and the outer peripheral wall of the pipe body 18, and a flow path 12 inlet is formed at a joint between the first through hole 15 and the inner peripheral wall of the pipe body 18; and a second through hole 14 penetrating the pipe wall of the pipe body 18 is disposed at an end position of the spiral diversion structure 11, so that the second through hole 14 communicates with the inner peripheral wall and the outer peripheral wall of the pipe body 18, and a flow path 12 outlet is formed at a joint between the second through hole 14 and the inner peripheral wall of the pipe body 18.

Since the two ends of the inner pipe 10 and the outer pipe 20 are all sealed by the expanded ports 13, a flow path 12 inlet or flow path 12 outlet needs to be disposed at the inner pipe 10 or outer pipe 20; the liquid inlet pipe 17 and liquid outlet pipe 16 adaptive thereto are disposed at the flow path 12 inlet or flow path 12 outlet. If the flow path 12 inlet or flow path 12 outlet is disposed at the outer peripheral wall of the outer pipe 20, the liquid inlet pipe 17 or the liquid outlet pipe 16 needs to be disposed at an outer surface of this liquid heating apparatus, which increases the volume of this liquid heating apparatus, so that it cannot be directly applied to an existing housing. Hence, in this embodiment, the flow path 12 inlet or flow path 12 outlet is disposed at the start position and end position of the spiral diversion structure 11 to communicate with the inner peripheral wall and outer peripheral wall of the pipe body 18; moreover, a certain distance from the end of the inner pipe 10 exists, so that the liquid may fully fill the flow path 12 for fully heating. The liquid inlet pipe 17 or liquid outlet pipe 16 is located at the inner peripheral wall of the inner pipe 10, extends in a direction from the liquid inlet 43 or liquid outlet 42 towards the openings of the two ends of the inner pipe 10, and is exposed at the openings at the two ends of the inner pipe 10. The liquid inlet pipe 17 or liquid outlet pipe 16 is disposed inside the inner pipe 10, which does not increase the volume of this liquid heating apparatus, and can be directly applied to the existing housing, facilitating machining and manufacturing. Moreover, there is a certain angle between the inlet of the liquid inlet pipe 17 or the outlet of the liquid outlet pipe 16 and the flow path 12 inlet or flow path 12 outlet, avoiding that the liquid cannot fully fill the flow path 12 to cause insufficient heating.

After the liquid to be heated enters the flow path 12 formed by the inner pipe 10, the spiral division structure 11, and the inner peripheral wall of the outer pipe 20 through the liquid inlet pipe 17 and via the first through hole 15, the heating assembly 21 integrated at the outer peripheral wall of the outer pipe 20 heats the flowing liquid while the liquid to be heated flows along the flow path 12. After passing through the outer pipe 20, the heat energy generated by the heating assembly 21 exchanges heat with the liquid in the flow path 12 to implement continuous heating of the liquid. After the liquid fully fills the flow path 12 and heating is completed, the liquid is discharged through the liquid outlet pipe 16 via the second through hole 14.

Preferably, a water pump (not shown in the figure) is disposed at the inlet of the liquid inlet pipe 17 to continuously deliver pressurized liquid into the flow path 12. Moreover, the diameter of the second through hole 14 is smaller than that of the first through hole 15, to keep the liquid pressure in the flow path 12 between the liquid inlet pipe 17 and the liquid outlet pipe 16 at 0.1-1.0 MPa.

Preferably, the heating assembly 21 is disposed at the outer peripheral wall on the outer pipe 20. The heating assembly 21 includes an insulating medium layer disposed on the outer peripheral wall of the outer pipe 20 and a heating circuit 22 disposed at the insulating medium layer; the insulating medium layer is printed and burned on the outer peripheral wall of the outer pipe 20; and the heat energy generated by the heating circuit 22 is used for heat exchange with the liquid flowing in the flow path 12. The heating circuit 22 includes a plurality of heating resistors and electrodes 24 fixed to the insulating medium layer. The extending direction of each heating resistor is consistent with the length direction of the outer pipe 20. Two ends of the heating resistor are respectively and electrically connected to the electrode 24. In this way, a power source is connected at the electrode 24 for the heating resistor to generate heat energy.

The liquid heating apparatus further includes a temperature sensor 23 and a controller electrically connected to the temperature sensor 23 (for example, using a PCB for control in this embodiment). The temperature sensor 23 is configured at the position of the outer pipe 20 adjacent to the liquid outlet 42. As can be seen from the figure that the first through hole 15 in this embodiment is provided in the inner pipe 10; the temperature sensor 23 is adjacent to the second through hole 14 as close as possible, and can be disposed at the axial position of the outer pipe 20 closest to the second through hole 14. The temperature sensor 23 can approximately detect the liquid temperature of the second through hole 14 by detecting the wall temperature of the outer pipe 20 close to the second through hole 14.

The PCB controls the water pump liquid inlet rate and/or the heating power of the heating resistor according to temperature information issued from a first temperature sensor 23. Preferably, the temperature sensor 23 is disposed at the position close to the liquid outlet 42 and away from the heating resistor as far as possible, so as to accurately detect the temperature of the liquid at the liquid outlet 42. In this way, the temperature sensor 23 is configured to detect the outlet liquid temperature and provide a feedback to the PCB. The PCB automatically adjusts the heating power of the heating resistor according to the comparison between the actually measured outlet liquid temperature data and the temperature required by liquid outflow and set by the user, or controls the water pump to adjust the flow rate of the liquid entering the flow path 12, so as to further implement accurate control over the outlet liquid temperature.

To facilitate uniform heating of the liquid in the flow path 12, the plurality of heating resistors are distributed around the outer peripheral wall of the outer pipe 20, and are preferably distributed approximately uniformly, so that the heating resistor faces the liquid in the flow path 12 to transfer heat energy to the flowing liquid in time.

The present invention further provides a method for preparing a liquid heating apparatus, where the method is used to prepare the liquid heating apparatus described above and includes the following steps.

S1: Prepare a mold according to preset parameters of an inner pipe 10, place the mold into a pressure device, and set parameters and debug the device, where the preset parameters include a pipe wall thickness of an inner pipe 10, a height of an expanded port 13, and a height and a spacing and a spiral diversion structure 11; and the inner pipe 10 pipe wall thickness is 0.3-1.0 mm, the surface height of the spiral diversion structure 11 at the outer peripheral wall of the inner pipe 10 is 1-5 mm, and the thread spacing is 5-20 mm.

S2: Place a metal material or a metal alloy material into the mold, and seal and lock the mold; and anneal the metal material or metal alloy material to lower the rigidity of the metal material or the metal alloy material. 304 stainless steel is selected in this embodiment, and has corrosion resistance, heat resistance, and good mechanical properties; moreover, the room temperature machining performance is relatively good, and erosion by food and a processing medium can be resisted.

S3: Start the pressure device, and perform push wave forming by using a high-pressure water drum, to complete machining, specifically including: using pressure to pressurize liquid in a limited space of the mold, and deforming the material by water pressure to make the material close to the mold shape, and integrally forming the spiral diversion structure 11 with the pipe body 18.

S4: Release pressure and loosen the mold, and take out the prepared inner pipe 10.

S5: Insert the inner pipe 10 in the outer pipe 20, so that a spacing between a highest point of the inner pipe 10 and the outer pipe 20 is 0.1-0.6 mm; align two ends of the inner pipe 10 and the outer pipe 20, and weld an opening through the expanded port 13 to implement sealing.

This liquid heating apparatus is manufactured by using this method. The inner pipe 10 made of the stainless steel material, the spiral diversion structure 11 is formed at the pipe body 18 by using the inner pipe 10 through water rising of the mold. This avoids the aging, unsafety, ease of falling off from the inner pipe 10, and other problems that are prone to occur when the diversion structure is separately added to the conventional heating apparatus, the manufacturing cost is reduced, machining for many times is not needed, and the cost is low. In addition, the expanded ports 13 are disposed at the openings at the two ends of the inner pipe 10. The inner pipe 10 is welded to the outer pipe 20 through the expanded ports 13, to implement the sealing of the flow path 12. The formed liquid heating apparatus is simple to assemble, has a good sealing effect, and meets mass industrial production, and the stability of the liquid heating apparatus in the high temperature and high pressure environment for a long time is improved.

The implementations above are only preferred implementations of the present invention and cannot be used to limit the scope of protection of the present invention. Any non-substantive change or replacement made by a person skilled in the art on the basis of the present invention shall fall within the scope of protection in the present invention.

What is claimed is:

1. An inner pipe for a liquid heating apparatus, comprising a hollow pipe body made of a metal or an alloy, wherein a pipe wall thickness of the pipe body is 0.3-1.0 mm; through a machining method of rolling or pressing, a spiral diversion structure is machined on an inner peripheral wall of the pipe body along an axial direction of the pipe body, so that the spiral division structure is formed to extend along the axial direction of the pipe body, protrude on an outer peripheral wall of the pipe body, and be sunken on the inner peripheral wall.

2. The inner pipe according to claim 1, further comprising expanded ports disposed at two ends of the pipe body and integrated with the pipe body.

3. The inner pipe according to claim 2, wherein on the inner peripheral wall of the pipe body, a first through hole penetrating a pipe wall of the pipe body is disposed at a start position of the spiral diversion structure, so that the first through hole communicates with the inner peripheral wall and the outer peripheral wall of the pipe body, and a flow path inlet is formed at a joint between the first through hole and the inner peripheral wall of the pipe body; and a second through hole penetrating the pipe wall of the pipe body is disposed at an end position of the spiral diversion structure, so that the second through hole communicates with the inner peripheral wall and the outer peripheral wall of the pipe body, and a flow path outlet is formed at a joint between the second through hole and the inner peripheral wall of the pipe body.

4. The inner pipe according to claim 3, wherein a surface height of the spiral diversion structure protruding on the outer peripheral wall of the pipe body is 1-5 mm, and a thread spacing is 5-20 mm.

5. A liquid heating apparatus, comprising:
the inner pipe according to claim 1, wherein openings at two ends of the inner pipe are sealed by end covers made of a metal material;
an outer pipe, wherein an inner peripheral wall of the outer pipe is spaced apart from a highest point of the spiral diversion structure by a predetermined radical clearance, so that the outer pipe is sleeved at an outer part of the spiral diversion structure; and a heating assembly is disposed on the outer peripheral wall of the outer pipe; wherein
the inner pipe, the outer pipe, and the spiral diversion structure form a flow path; openings at two ends of the flow path are sealed by sealing covers; the sealing cover is provided with a liquid outlet or a liquid inlet; and liquid enters the flow path through the liquid inlet of the sealing cover for heating and is discharged from the liquid outlet.

6. A liquid heating apparatus, comprising:
the inner pipe according to claim 3, and
an outer pipe, wherein an inner peripheral wall of the outer pipe is spaced apart from a highest point of the spiral diversion structure by a predetermined radical clearance, so that the outer pipe is sleeved at an outer part of the spiral diversion structure; and a heating assembly is disposed on the outer peripheral wall of the outer pipe; wherein
the inner pipe, the outer pipe, and the spiral diversion structure form a flow path; and openings at two ends of the flow path are sealed by the expanded ports.

7. The liquid heating apparatus according to claim 6, wherein a liquid inlet pipe is disposed at an inlet of the flow path; a liquid outlet pipe is disposed at an outlet of the flow path; and the liquid inlet pipe or the liquid outlet pipe extends towards directions of the openings of two ends of the inner pipe through the first through hole or the second through hole, and is exposed at the openings at the two ends of the inner pipe.

8. The liquid heating apparatus according to claim 7, wherein the expanded port is welded to and sealed with an end of the outer pipe; and the liquid inlet pipe or the liquid outlet pipe is welded to the first through hole or second through hole.

9. The liquid heating apparatus according to claim 5, wherein the liquid inlet pipe is connected to a water pump, and a diameter of the liquid outlet pipe is not greater than a diameter of the liquid inlet pipe, to keep a liquid pressure in the flow path at 0.1-1.0 MPa.

10. The liquid heating apparatus according to claim 8, wherein the liquid inlet pipe is connected to a water pump, and a diameter of the liquid outlet pipe is not greater than a diameter of the liquid inlet pipe, to keep a liquid pressure in the flow path at 0.1-1.0 MPa.

11. The liquid heating apparatus according to claim 8, wherein the inner pipe and the expanded port are both made of a stainless steel material.

12. The liquid heating apparatus according to claim 9, further comprising a temperature sensor and a controller electrically connected to the temperature sensor, wherein the temperature sensor is configured at a place of the outer pipe close to the second through hole, and the controller is configured to control, according to temperature information issued by the temperature sensor, the water pump liquid inlet speed and/or heating power of the heating assembly.

13. A method for preparing a liquid heating apparatus, wherein the method is used to prepare the liquid heating apparatus according to claim 6 and comprises the following steps:
S1: preparing a mold according to preset parameters of an inner pipe, and placing the mold into a pressure device; and setting parameters and debugging the device, wherein the preset parameter comprises an inner pipe thickness, a height of an expanded port, and a height and a spacing of a spiral diversion structure;
S2: placing a metal material or a metal alloy material into the mold; sealing and locking the mold; and annealing the metal material or metal alloy material;
S3: starting the pressure device, performing pushing wave forming by using a high-pressure water drum, to complete machining, and integrating the spiral diversion structure with a pipe body;
S4: releasing pressure and loosening the mold, and taking out the prepared inner pipe; and
S5: sleeving the inner pipe in an outer pipe, so that a spacing between a highest point of the inner pipe and the outer pipe is 0.1-0.6 mm; aligning two ends of the inner pipe and the outer pipe; and welding an opening to implement sealing.

14. A method for preparing a liquid heating apparatus, wherein the method is used to prepare the liquid heating apparatus according to claim 9 and comprises the following steps:
S1: preparing a mold according to preset parameters of an inner pipe, and placing the mold into a pressure device; and setting parameters and debugging the device, wherein the preset parameter comprises an inner pipe thickness, a height of an expanded port, and a height and a spacing of a spiral diversion structure;
S2: placing a metal material or a metal alloy material into the mold; sealing and locking the mold; and annealing the metal material or metal alloy material;
S3: starting the pressure device, performing pushing wave forming by using a high-pressure water drum, to complete machining, and integrating the spiral diversion structure with a pipe body;
S4: releasing pressure and loosening the mold, and taking out the prepared inner pipe; and
S5: sleeving the inner pipe in an outer pipe, so that a spacing between a highest point of the inner pipe and the outer pipe is 0.1-0.6 mm; aligning two ends of the inner pipe and the outer pipe; and welding an opening to implement sealing.
